(19) United States
(12) Patent Application Publication
(10) Pub. No.: US 2023/0047561 A1
(43) Pub. Date: Feb. 16, 2023

(54) AIRFRYING SYSTEM AND METHOD

(71) Applicant: KAVARING COOKING SYSTEMS B.V., Wassenaar (NL)

(72) Inventors: Lars LIEBERWIRTH, Wassenaar (NL); Hans BROCKER, Wassenaar (NL); Stephan HOLTRUP, Erkelenz (DE); Klaus WERNER, Wijchen (NL)

(73) Assignee: KAVARING COOKING SYSTEMS B.V., Wassenaar (NL)

(21) Appl. No.: 17/793,687

(22) PCT Filed: Jan. 28, 2021
(86) PCT No.: PCT/NL2021/050055

§ 371 Date: Jul. 19, 2022

(30) Foreign Application Priority Data
Jan. 28, 2020 (NL) 2024781

(51) Int. Cl. A47J 37/06; A23L 5/10; H05B 6/72

(52) U.S. Cl. CPC A47J 37/0641; A23L 5/15; H05B 6/72; H05B 6/702

(57) ABSTRACT

A system for preparing food that includes a holder for holding the food and an apparatus. The apparatus includes a processing chamber that is RF-impermeable and air-impermeable, a holding device for holding the holder inside the processing chamber, an RF-antenna to radiate RF-energy to the inside of the processing chamber for heating the food inside the holder, a fan for circulating the air in the processing chamber through an air-permeable side and through the holder, and a heater to provide heat to the circulated air. The fan and the heater are to air fry the food inside the holder. The processing chamber includes a top shell having a top inner space and a top rim forming an access opening to the top inner space, and a bottom shell having a bottom inner space and a bottom rim forming an access opening to the bottom inner space. In a closed position, the top shell and the bottom shell are to envelop an interior space that includes the top inner space and the bottom space. The processing chamber is shaped such that the RF-wave has a node substantially at the top rim and/or the bottom rim in the closed position.

### CROSS-REFERENCE TO RELATED APPLICATIONS

The present application is a National Stage Application of PCT International Application No. PCT/NL2021/050055 (filed on Jan. 28, 2021), under 35 U.S.C. § 371, which claims priority to Dutch Patent Application No. 2024781 (filed on Jan. 28, 2020), which are each hereby incorporated by reference in their complete respective entireties.

### TECHNICAL FIELD

The invention relates to the field of preparing food by cooking with hot air, such as air fryers and methods for air frying, more particular to the field of air frying food and methods for air frying food.

### BACKGROUND

An air fryer is a kitchen appliance that cooks by circulating hot air around the food using the convection mechanism. A mechanical fan circulates the hot air of up to 230° C. around the food at high speed, cooking the food and producing a crispy layer. The crispy layer is typically thin for providing the crispy effect while retaining the moisture in the core of the food. The core of the food heats typically by conduction.

The foods cooked in an air fryer are typically snacks, such as potato chips, chicken, chicken wings, fish, fish sticks, steak, spare ribs, or french fries, which were previously often fried in hot oil, as well as quiche, pies, eggrolls, croquettes and even breadrolls and croissants. These foods are mostly stored deep-frozen.

A disadvantage is that the known air fryers when used with a considerable amount of deep-frozen food fried at once, either produce food which is fried or even burned on the outside, while the core of the food is still cold or even frozen or takes a prolonged time to prepare. To circumvent this problem, the chamber holding the food of current air fryers is designed small, adding another disadvantage. Another disadvantage is that the current air fryers, due to the size of the chamber holding the food, are only suitable for home-use and not for commercial-use, such as use in restaurants, bars, cafés, brasseries, cafeterias, fast-food restaurants or the like.

### SUMMARY

An object of the invention is to mitigate the disadvantages as mentioned above. According to a first aspect of the invention, a system for preparing food, comprising: a radio frequency (RF)-impermeable layer; a holder for holding the food, comprising: an air-permeable side; an apparatus comprising: a processing chamber arranged for being RF-impermeable and preferably air-impermeable; holding means for holding the holder inside the processing chamber; an RF-antenna arranged to radiate RF-energy to the inside of the processing chamber for heating the food inside the holder; a fan for circulating the air in the processing chamber through the air-permeable side and through the holder; and a heater arranged to provide heat to the circulated air; wherein the fan and the heater are arranged for air frying the food inside the holder; wherein the RF-impermeable layer is also air-permeable and at least in use arranged substantially parallel to the air-permeable side of the holder; wherein the RF-impermeable layer in use separates the processing chamber in a first area susceptible to RF-energy from the RF-antenna and a second area shielded against RF-energy from the RF-antenna; and wherein the fan is arranged in the second area.

The process of air frying is cooking by circulating hot air around the food inside the system. The circulation of the hot air is forced by the fan moving the air. The fan circulates, swirls and/or propels the hot air, which may be heated up to 230° C. around the food at high speed, cooking the food and producing a crispy layer.

An air-permeable side should be air-permeable for hot air typically at high speed as used in an air fryer. Examples of an air-permeable side are a mesh of a particular plastic able to withstand the hot air, a metal layer with openings in it or a mesh of metal, or other materials such as made from ceramic or others.

An air-impermeable side or wall does only have to be air-impermeable to the hot air circulating at high speed in the air fryer. It does not necessarily be airtight. The air-impermeable side or wall should at least prevent hot air from the inside harming or burning a person outside the system.

An RF-impermeable layer or wall is a layer that blocks the propagation of RF-waves of a specified frequency or frequency range. The RF-impermeable layer or wall may reflect, absorb, scatter, or a combination of the previous. The RF-impermeable layer is typically RF-impermeable for at least a part, preferably all, of the frequencies of the RF-energy radiated by the RF-antenna. The RF-impermeable layer may be a metal layer, mesh of metal, or the like. The RF-impermeable layer may even be a metal layer with openings having a size adapted to prevent RF-waves from leaking through that layer.

The processing chamber typically comprises a wall. The wall of the processing chamber is RF-impermeable and air-impermeable. It prevents in use that a person standing outside the processing chamber and next to the system is exposed to any dangerous RF-radiation and/or hot air. As the food needs to be brought into the processing chamber and taken out again, the processing chamber typically comprises an opening. The processing chamber, e.g., may comprise two shell halves fitting together tightly. The two shell halves provide the RF-impermeable and air-impermeable processing chamber when fit together. While, when the two shell halves are separated, the shell half holding the food provides easy access to this food. Special geometric and material considerations prevent RF-leakage into areas where the RF-impermeable wall gets divided for chamber openings or access of motor, temperature sensors, or antenna; it prevents RF-leakage in those areas by confining the RF-wave to within the RF-impermeable boundaries.

It is an insight of the inventor that the tight packing of the food and/or the large volume of the pieces of the food result in food with an outside cooked or even burned, while the inside stays cold or even frozen. The heat conductivity of frozen food is different compared to the heat conductivity of unfrozen food. It is an insight of the inventor that if the outside of a large piece of food or tightly packed food heats, due to the difference of conductivity, only the outer shell of the food is cooked if the temperature of the surrounding air is too high. This negative effect is amplified if the volume of food is larger and prevents the use of prior art air fryers for commercial-use, such as used in restaurants, bars, cafés, brasseries, cafeterias, fast-food restaurants or the like.

It is an insight of the inventor that if the food would evenly transition from a frozen state to a non-frozen state, the air frying may be used in the non-frozen state to obtain typical air fried food in larger volumes. Furthermore, the air fried food will next to the crispy outside also obtain an evenly cooked inside. It is a further insight of the inventor that evenly transitioning larger amounts of food in relatively short amounts of time may be obtained with the use of RF-waves, typically capable of penetrating larger amounts of food. RF-waves penetrating the frozen food may evenly or at least also inside the food, heat the food up for a more evenly transition of the food from a frozen to an unfrozen state.

The known fan is typically made of metal, such as steel, to provide an easy producible and low in cost fan. These fans are a distortion to the RF-waves. And even if the fan is made of plastic having a dielectric constant notable different from the surrounding air, the fan will disturb the RF-waves. Furthermore, the axle of the fan is typically made of metal, also disturbing the RF-waves. It is an insight of the inventor to change the arrangement of the components of the air fryer, such that the air fryer may incorporate the heating of the food with RF-energy.

The system comprises a processing chamber for holding the food inside the processing chamber, wherein the system has components arranged such that the food may be exposed to RF-energy as well as an air fryer effect. This has the technical effect of increasing the evenness of the cooking of the cooked food in a relatively short amount of time.

As the fan is arranged in an area of the processing chamber that is not or minimally exposed to the RF-energy or such a low level or RF-energy that it does not or minimally disturb the RF-waves, the RF-energy may efficiently be transferred to the food. The word area in the context of the claim is used to identify the boundaries of where the RF-energy is or predominantly is. Alternative wording for the area may be part of the processing chamber, section of the processing chamber, cavity of the processing chamber, or space of the processing chamber. The technical effect of that the RF-impermeable layer is also air-permeable, and at least in use arranged substantially parallel to the air-permeable side of the holder; the enclosed space may be separated in two areas. A first area is accessible to hot air having an air frying effect and RF-energy heating the food. And a second area accessible to hot air having the air frying effect. Now by arranging the food in the first area and the fan in the second area, the technical effect is obtained from the fan, not disturbing the RF-waves.

Additionally, the term substantially parallel or parallel in the context of this invention is to be understood as two layers or a layer and a side being placed on top of each other or spaced by some distance. Two layers being parallel may have a small angle relative to each other, e.g. a few degrees. Typically, these deviations from parallel are within the limitations of the production.

In an embodiment of the invention, the provision of RF-energy to the food inside the holder is independent of the provision of heated air to the food inside the holder. This provides the advantage that during the phase change of the food from frozen to unfrozen, the food may be exposed to RF-energy while the circulation of hot air may be stopped or minimized. This also provides the advantage of dependent on the settings cooking the food in the unfrozen state that may be done by the hot circulating air and/or RF-energy.

In an embodiment of the invention, the air-permeable side is arranged for allowing a vertical stream of air through the holder. The air is advantageously a vertical stream of air through the food. Depending on the settings and/or the capabilities of the system, the vertical stream of air through the food may be from top-to-bottom or from bottom-to-top. Alternatively, the system may alter the vertical direction of the air stream through the food, such as pulsing one vertical direction and, after that, the opposite vertical direction.

In an embodiment of the invention, the air-permeable side of the holder is advantageously arranged as an air-permeable bottom side. It provides an advantageous entry point for the air stream to the food.

In an embodiment of the invention, the holder comprises the RF-impermeable layer. In an advantageous further embodiment of the invention, the RF-impermeable layer is a bottom-side of the holder, preferably wherein the RF-impermeable layer and the air-permeable side are integrated. It provides the advantage of aligning the RF-impermeable layer and the air-permeable side by design for optimizing the conductance of air through the RF-impermeable layer.

In an embodiment of the invention, the RF-impermeable layer is a top-side of the holder. Typically, the bottom side of the holder also contains an air-permeable bottom side for allowing air to pass through the holder vertically, and thus the food hold inside the holder.

In an embodiment of the invention, the holding means are at least partly RF-impermeable for in use together with the RF-impermeable layer forming an RF separation in the processing chamber. The holder is typically leaving a space between the holder and the processing chamber for allowing air to circulate back after passing through the holder. The RF-energy may leak through this space from the first to the second area. The holding means typically extend from the holder, at least partly bridging the space between the holder and the processing chamber. The holding means may, therefore advantageously extend the RF-impermeable layer for decreasing the leakage of RF-energy to the second area.

In an embodiment of the invention, the heater is advantageously arranged in the second area. The heater typically comprises metal parts or at least parts influencing RF-waves. The heater is, therefore, best arranged inside the second area where due to the absence or low amount of RF-energy; the heater causes the least disturbance to the RF-waves. It is noted that especially the grounding of the heater may cause a disturbance of the RF-waves if the heater is not in an area shielded from the RF-waves. In an alternative embodiment, the heater is an indirect heater, wherein the heater heats at least a part of the processing chamber whereupon at least part of the processing chamber conducts the heat to the air passing along the at least part of the processing chamber. It provides the advantage that the heater may virtually be arranged to every location on the outside of the processing chamber.

In an embodiment of the invention, the heater is at least partly RF-impermeable for in use, together with the RF-impermeable layer forming an RF-separation in the processing chamber. In a further embodiment, the holding means are advantageously also part of the RF-separation for improving the RF-barrier for reducing the RF-energy in the second area, thus thereby minimizing the disturbance of the components in the second area on the RF-waves.

In an embodiment of the invention, the system comprises: an RF-source arranged for providing RF-energy to the RF-antenna; a motor for driving the fan; a heater source for providing energy to the heater; and a controller for controlling the amount of RF-energy from the RF-source, the number of revolutions of the motor, and the amount of radiated heat from the heater, wherein the controller controls the RF-source, the motor, and the heater independently. The controller may advantageously control the different parameters for providing the optimal cooking result and the homogeneous transition of the food from a frozen to an unfrozen state in a minimum of time.

In an embodiment of the invention, the holder is a food basket. Typically, the food basket has a bottom side made of an RF-impermeable mesh, such as a metal mesh, thereby advantageously integrating the air-permeable side and the RF-impermeable layer.

According to another aspect of the invention, a system for preparing food, comprising: an RF-impermeable layer; a holder for holding the food, comprising: an air-permeable side; an apparatus comprising: a processing chamber arranged for being RF-impermeable impermeable and air-impermeable; holding means for holding the holder inside the processing chamber; an RF-antenna arranged to radiate RF-energy to the inside of the processing chamber for heating the food inside the holder; a fan for circulating the air in the processing chamber through the air-permeable side and through the holder; and a heater arranged to provide heat to the circulated air; wherein the fan and the heater are arranged for air frying the food inside the holder; wherein the RF-impermeable layer is also air-permeable and at least in use arranged substantially parallel to the air-permeable side of the holder; wherein the RF-impermeable layer in use separates the processing chamber in a top area susceptible to RF-energy from the RF-antenna and a bottom area shielded off from RF-energy from the RF-antenna; and wherein the fan is arranged in the bottom area. This aspect of the invention provides the same advantages as mentioned throughout the text for the other aspects of the invention.

In an embodiment of the invention, the apparatus comprises a motor for driving the fan, wherein the motor is arranged below the processing chamber. The motor is typically the largest or one of the most substantial mass objects in the apparatus. Arranging the motor low in the apparatus provides the advantage of a low point of gravity, thus improving the mechanical stability of the apparatus or system as a whole. This becomes especially an advantage if the holder is during loading, unloading and/or placing located partly outside the processing chamber, but still resting on the processing chamber or coupled to the apparatus. The holder and the food in the holder may, in this case, destabilize the apparatus or make the apparatus tilt. Placing the motor below the processing chamber decreases the change of tilting of the apparatus during loading, unloading and/or placing of the holder.

In an embodiment of the invention, the processing chamber defines a vertical axis substantially being a line of symmetry, wherein the motor aligns with this vertical axis. The system is for the more significant part symmetric around the vertical axis. Therefore, the air stream circulating inside the processing chamber for the air frying effect is predominantly symmetrical and is substantially taking the shape of a donut. Arranging the fan to this predominantly donut-shape advantageously simplifies stimulating this substantially donut-shaped air stream. Furthermore, arranging this motor substantially with the vertical axis provides the advantage of the motor axle driving the fan directly, thus simplifying the design of the apparatus as well as the number of components of the apparatus, thus minimizing the change of failure of the apparatus or system as a whole.

In an embodiment of the invention, the processing chamber defines a vertical axis substantially being a line of symmetry, wherein the processing chamber comprises a backplane having a first backplane end and a second backplane end, wherein a triangle defines a vertical projection of the vertical axis, the first backplane end, and the second backplane end, wherein the centre point of gravity of the motor is arranged inside this triangle.

Arranging the motor low in the apparatus provides the advantage of a low point of gravity, thus improving the mechanical stability of the apparatus or system as a whole. This becomes especially an advantage if the holder is during loading, unloading and/or placing located partly outside and in front of the processing chamber, but still resting on the processing chamber or coupled to the apparatus or rest of the system. The holder and the food in the holder may, in this case, destabilize the apparatus or make the apparatus tilt. Placing the motor below the processing chamber decreases the change of tilting of the apparatus during loading, unloading, and/or placing of the holder.

This embodiment provides the further advantage that if the holder, while coupled to the apparatus during loading, unloading and/or placing is arranged in front of the apparatus, the motor acts as counterweight improving the balance preventing tilting of the apparatus or the system as a whole.

In an embodiment of the invention, the apparatus comprises an axle that is shared between the motor and the fan for directly driving the fan. This embodiment provides the advantage of reducing the number of components and thus reducing the change on failure.

In an embodiment of the invention, the holder is a food basket, preferably a food basket having an RF-impermeable and air-permeable bottom side, such as a metal mesh, and/or RF-permeable and air-impermeable sides, such as particular plastics.

According to another aspect of the invention, a system for preparing food, comprising: an apparatus comprising: a processing chamber arranged for being RF-impermeable and air-impermeable and comprising a processing chamber surface; an RF-antenna arranged to radiate RF-energy to at least a part of the inside of the processing chamber for heating the food inside the processing chamber; and an RF-transparent layer having an RF-transparent surface and sealing off the RF-antenna from the part of the processing chamber arranged for holding the food. During the preparation or cooking of food inside the processing chamber, the food may spatter, splutter, fizz, or splash due to, e.g., gas-forming inside the food during the cooking. Food scraps or food splashes may hit the surface of the processing chamber. These food scraps or food splashes should be removed timely and thoroughly as if not removed properly; these may cause health issues with food later cooked inside the processing chamber.

The RF-antenna is edged and bent, typically sharply edged and bent, for radiating the RF-energy with the desired efficiency and RF-mode. The edges and bents of the RF-antenna make it challenging to clean. By covering the RF-antenna with an RF-transparent layer, the food scraps or food splashes cannot bind with the RF-antenna. The sealing is thus for sealing off for food inside the processing chamber, preferably slashes or scraps of food originating from inside the holder.

In an embodiment of the invention, the system comprises a fan, a heater, and an air path for circulating hot air inside the processing chamber for air frying typically as specified for the other aspects of the invention. Air frying may cause the food to spatter, splutter, fizz, or splash. When the air frying is combined with RF-cooking, the advantage of improved cleaning becomes even more beneficial.

The health issue becomes even more important as an uncovered RF-antenna inside a processing chamber also providing means for air frying may heat the RF-antenna, while not heating the RF-antenna enough to carbonize the food on the RF-antenna. Therefore, the uncovered RF-antenna has being typically challenging to clean. Furthermore, due to the increased temperatures inside the processing chamber, the food scraps or food splashes may bind stronger with the uncovered RF-antenna, making cleaning even harder.

In an embodiment of the invention, the RF-transparent layer seamlessly joins the processing chamber surface for further improving the cleaning of the processing chamber or easing the removal of food scraps or food splashes. In an embodiment of the invention, the RF-transparent surface seamlessly joins the processing chamber surface for further improving the cleaning of the processing chamber or easing the removal of food scraps or food splashes. In an embodiment of the invention, at least the edge of the RF-transparent surface is flush with the processing chamber surface for further improving the cleaning of the processing chamber or easing the removal of food scraps or food splashes. In an embodiment of the invention, the processing chamber comprises a protrusion, preferably an outward protrusion, wherein the RF-antenna is arranged in the protrusion for further improving the cleaning of the processing chamber or easing the removal of food scraps or food splashes. In an embodiment of the invention, the RF-transparent surface is a flat, substantially flat, slightly rolling, or slightly bent surface for further improving the cleaning of the processing chamber or easing the removal of food scraps or food splashes. The amount of rolling or bending depends on the shape of the processing chamber to seamlessly fitting into the curvature of the processing chamber.

In an embodiment of the invention, the RF-transparent surface is flush with the processing chamber surface for further improving the cleaning of the processing chamber or easing the removal of food scraps or food splashes. This embodiment is particularly well combined with the embodiment wherein the RF-transparent surface is flat and/or the embodiment wherein the processing chamber comprises an outward protrusion wherein the RF-antenna is arranged for providing a flat, substantially flat, slightly rolling or slightly bend surface to be cleaned.

In an embodiment of the invention, the RF-antenna is a substantially flat antenna. This embodiment is particularly well combined with the embodiment wherein the processing chamber comprises an outward protrusion wherein the RF-antenna is arranged for providing a flat surface to be cleaned. The flat or substantially flat RF-antenna provides the advantage that the protrusion does not need to be too deep.

In an embodiment of the invention, the RF-antenna is an inverted-F antenna, or a PIFA antenna, preferably an inverted dipole known as a slot-antenna or multiples of such antennae. These are advantageous types of RF-antennae, able to transmit inside the desired frequency range or more than one frequency range, and being substantially flat.

According to another aspect of the invention, a system for preparing food, comprising: an RF-impermeable layer; a holder for holding the food, comprising: an air-permeable side; an apparatus comprising: a processing chamber arranged for being RF-impermeable impermeable and air-impermeable; holding means for holding the holder inside the processing chamber; an RF-antenna arranged to radiate RF-energy to the inside of the processing chamber for heating the food inside the holder; a fan for circulating the air in the processing chamber through the air-permeable side and through the holder; and a heater arranged to provide heat to the circulated air; wherein the fan and the heater are arranged for air frying the food inside the holder; wherein the RF-impermeable layer is also air-permeable and at least in use arranged substantially parallel to the air-permeable side of the holder; wherein the RF-impermeable layer in use separates the processing chamber in a first area susceptible to RF-energy from the RF-antenna and a second area shielded off from RF-energy from the RF-antenna; and wherein the fan is arranged in the second area. This aspect of the invention provides the same advantages as mentioned throughout the text for the other aspects of the invention.

In an embodiment of the invention, the holder having a size, which holder occupies in use only a section of the first area such that the unoccupied section of the first area is sized and/or shaped to receive the RF-energy from the RF-antenna for generating an RF-wave in the unoccupied section for efficiently transferring the RF-energy from the RF-antenna to the food in the holder. It is an insight of the inventor that the food held in the holder disturbs the RF-wave or forming of the RF-wave. The unoccupied section effectively provides a favourable transition space from the RF-antenna and the food for efficiently transferring the RF-energy from the RF-antenna to the food. Experiments and simulations of the inventor have shown that the unoccupied space needs to be at least half of the first area, which is the area where RF-energy can be available. In a further embodiment, the height of the holder is less than or equal to half the height of the first area. Furthermore, experiments and simulations have shown that the holder may have a width and length comparable or close to the width and length of the first area. It should be born in mind that the holder should have a width and length still allowing air to circulate for the air frying effect, which air along the circulation path typically also passes between the holder and the processing chamber in a vertical direction and after that being blown or sucked through the food in the holder.

In an embodiment of the invention, the dominant RF-wave in the unoccupied section is a standing RF-wave. The size and/or shape of the first area, typically at least the length and the width, are selected such that one or two standing waves are formed. A standing wave provides a means for efficiently transferring the RF-energy from the RF-antenna to the food at a well-defined location with high electromagnetic energy density. A standing wave may have energy hotspots. A further advantage may be to have two dominant standing waves for more evenly spreading the RF-energy inside the food. To enhance the forming of two dominant standing waves, the length and width of the first area may be selected slightly different.

In an embodiment of the invention, the dominant standing RF-wave in the unoccupied section may be an RF-wave having TE-mode 011, TE-mode 111, and/or TM-mode 110. Especially the combination of TE-mode 011 and TE-mode 111 seem beneficial as these modes require substantially the same length and width of the first area for being the dominant standing RF-waves.

In an embodiment of the invention, the RF-antenna operates in a frequency range fully penetrating the food in the holder, wherein the food in the holder has a weight over 2 Kg, preferably 3 Kg, more preferably over 4 Kg. These amounts of food are typically used in commerce and not for home use. The frequency for the RF-waves and the size and/or shape of the processing chamber are to be advantageously selected and sized and/or shaped respectively to accommodate this amount of food in the holder.

In an embodiment of the invention, the RF-antenna operates in a frequency range fully penetrating the food in the holder, wherein the frequency range is below 1 GHz, preferably within the 902 to 928 MHz band or substantially 915 MHz. The amounts of food, as specified above, have to be penetrated by the RF-waves for providing the RF-energy everywhere inside the food. The typically used frequency of 2.45 GHz is less suitable as the penetration depth is only in the range of centimetres, thus not good enough to penetrate food blocks weighing over 2 Kg. Selecting a lower frequency advantageously allows the RF-wave to penetrate the food deeper, instead of only heating the outside layer of the food. If the frequency is selected even such low that the RF-wave traversing through the food is only partially absorbed, the RF-wave may consequently bounce back from the processing chamber and/or RF barrier separating the first and second area for thereafter traversing the food again for heating the food by being absorbed. It provides the advantage that the food is more evenly heated during, e.g., the transition from frozen to unfrozen. This provides the further advantage that the food is less heated with hotspots determined by the standing wave, but also by the more randomized reflections enhancing the evenly spreading of absorbed RF-energy in the food.

It is an insight of the inventor, based on extensive characterization of various food and conditions, that the frequency range of 902 to 928 MHz has one or more advantages over other frequencies such at the range of 2400 to 2500 MHz. Also, in various countries, this frequency band of 902 to 928 MHz can be freely used, unlicensed band. In many other countries however, very strict regulations apply for that frequency range and provisions have to be taken to prevent electro-magnetic-interference. Hence, selecting a frequency in this range advantageously eases the compliance with those different requirements and still achieves a good performance, especially at 2.45 GHz ISM band worldwide and not only at the 915 MHz band for the Americas. Thus, production is simplified by selecting a frequency in this range, while this frequency range also provides the benefit of high penetration of the food in the holder.

In a further preferred embodiment, the dominant RF-waves have a frequency below 1 GHz, preferably within the 902 to 928 MHz band or substantially 915 MHz, and the dominant RF-waves have at least one, preferably both, a TE-mode 011 and/or a TE-mode 111. Experiments and tests of the inventor have shown that with the before mentioned parameters, the length and width of the processing chamber get in the range of 250 to 380 mm, preferably in the range of 280 to 340 mm, more preferably around 306 mm. This dimension may also refer to a certain size of the RF-impermeable wall of the holder and may be adjusted accordingly to the overall, effective processing chamber. The height of the first area during experiments and tests was in the range of 180 mm, more specifically 192 mm, while the height of the holder was less than 60% of the height of the first area. Furthermore, it was assumed that the dielectric constant of air was around 1, of the RF-permeable sides of the holder around 3-10, depending on the material of the holder, such as PTFE, PEEK, fibreglass or ceramics, and of the frozen food around 80, while unfrozen but cold food may be around 3. Typically, as temperature increases, permittivity of the food ends up around 40 for main water-based food products, e.g. hot snack food with moist insides, while the crispy crust settle around 80. These dimensions are well suited for holding more substantial amounts of food, especially for commercial-use. This embodiment may be valid for compact size general equipment or counter-top equipment, it may be further enhanced by selecting a different length and width for the first area, but still in the range specified for advantageously spreading the RF-energy more evenly, as specified before. For larger size equipment, beyond counter-top placements, a frequency of 433 MHz could be selected to support food loads of 8 kg and more.

In a further preferred embodiment, the dominant RF-waves have a frequency below 1 GHz, preferably within the 902 to 928 MHz band or substantially 915 MHz, and the dominant RF-wave has a TM-mode 110. Experiments and tests of the inventor have shown that with the before mentioned parameters, the length and width of the processing chamber get in the range of 200 to 260 mm, preferably in the range of 220 to 240 mm, more preferably around 230 mm. The height of the first area during the experiments and tests was in the range of 180 mm, while the height of the holder was less than half the height of the first area. Furthermore, it was assumed that the dielectric constant of air was around 1, of the RF-permeable sides of the holder around 2 (PTFE), 3 to 4 (PEEK, fibreglass) to around 10 (ceramics) and the permittivity of the food in a very wide range from 3 to 80; while very low numbers may hold for frozen food and high numbers for cold but non-frozen food. As temperature increases, permittivity typically drops to around 40; this holds for mainly water-based food products, e.g. hot snack food with moist insides and crispy crust. These dimensions are well suited for holding more substantial amounts of food, especially for commercial-use.

According to another aspect of the invention, system for preparing food, comprising: a holder for holding the food, comprising: an air-permeable side (121); an apparatus comprising: a processing chamber arranged for being RF-impermeable and preferably air-impermeable; holding means for holding the holder inside the processing chamber; an RF-antenna arranged to radiate RF-energy to the inside of the processing chamber for heating the food inside the holder; a fan for circulating the air in the processing chamber through the air-permeable side and through the holder; and a heater arranged to provide heat to the circulated air; wherein the fan and the heater are arranged for air frying the food inside the holder; wherein the processing chamber comprises: a top shell comprising a top inner space and a top rim forming an access opening to the top inner space; and a bottom shell comprising a bottom inner space and a bottom rim forming an access opening to the bottom inner space; wherein in a closed position the top shell and the bottom shell are arranged to each other to envelop an interior space comprising the top inner space and the bottom space; wherein the radiated RF-energy generates an RF-wave; and wherein the processing chamber is shaped such that the RF-wave has a node substantially at the top rim and/or the bottom rim in the closed position.

The top shell and the bottom shell may alternatively be identified as a top pan and a bottom pan, respectively. In a further embodiment of the invention, wherein the top inner space and the bottom inner space together form the inside of the processing chamber.

A node of an RF-wave may be understood as a minimum for the RF-energy and/or a volume in space where the RF-energy is minimal, such as below a predefined threshold. The threshold may be 10% of the range between the maximum RF-energy value and the minimum RF-energy value. The RF-energy may use a linear, a dB or logarithmic scale. A node of an RF-wave contacting or adjacent to a wall, such as a conductive wall e.g. a metal wall, induces a minimum current density. A node of an RF-wave contacting or adjacent to a wall, such as a conductive wall e.g. a metal wall, induces a minimum current density area in the wall. It is an insight of the inventor that at the rims, such as where the top shell and the bottom shell contact or are adjacent in a closed position, the flow of current in the wall of the processing chamber is disturbed. And when the flow of the current in the wall of the processing chamber is disturbed, the RF-wave and consequentially the standing wave is disturbed. By aligning a node of the RF-wave with one of the rims, such as where the two shells meet, the disturbance of the RF-wave is reduced. This reduction of the disturbance allows the RF-wave, or standing RF-wave, to form with a reduced amount of radiated RF-energy put into the RF-wave. Thus, the effect of arranging or aligning a node of RF-wave with one of the rims provides a system with higher efficiency and/or improved transfer of radiated RF-energy from the RF-antenna and into the food in the holder.

In an embodiment of the invention, in an open position the top shell and the bottom shell are arranged to each other to allow loading and unloading of the holder into and out of the processing chamber. This advantageously allows food to be transported between the processing chamber and the outside.

In an embodiment of the invention, the top shell has a top shell height; the bottom shell has a bottom shell height; and the top shell height and the bottom shell height are substantially the same. This embodiment advantageously abets and/or promotes the RF-waves, such as standing RF-waves, in the top inner space such that variations in the bottom inner space, typically holding the holder preferably with food, to benefit from the RF-waves that RF-energy may be absorbed in the bottom inner space, typically by the food. In a preferred embodiment, the diameter of the second inner space is substantially slightly larger than 10″, such as that a 10″ pizza would fit in the holder. In a preferred embodiment the top shell height and the bottom shell height are in a range from 90 mm to 125 mm, preferably from 90 mm to 115 mm, more preferably 90 mm to 100 mm, most preferably substantially 96 mm. In a preferred embodiment, the diameter and the height of the top shell and/or the bottom shell are within the preceding ranges. The combination provides the advantages of abetting or promoting RF-waves, such as standing RF-waves or RF-modes, which optimize the absorption of RF-energy by the bottom inner space, such as food in the holder.

In an embodiment of the invention, in the closed position the top rim and the bottom rim contact each other, join each other and/or are adjacent to each other for forming the RF-impermeable and preferably air-impermeable processing chamber. The rims are typically where the processing chamber closes and forms a splice or clearance. Furthermore, RF-waves induce currents in the walls of the processing chamber. It is an insight of the inventor that these currents are absent or minimal in the walls at the location where the RF-waves have a node and that these currents are maximal in the walls at the locations where the RF-waves have an anti-node. The top rim and/or the bottom rim are advantageously arranged at a location of a node, such that the influence of the top rim and/or the bottom rim, preferably the splice and/or clearance, has minimal influence on the RF-waves, such as the promoted RF-waves. The current embodiment advantageously allows to simplify and/or add mechanical tolerance on how the top and bottom shell are joint in the closed position. Further, the RF-waves are advantageously optimized as the loss of RF-energy in the walls of the processing chamber, specifically where the top shell and the bottom shell join or connect, is reduced or minimized. Specific RF-modes may provide a standing RF-wave according to this embodiment are TE-mode xx1, TM-mode xx1, and TM-mode xx0, additional higher-order TE- and/or TM-modes will typically appear at higher frequencies, e.g. 2450 MHz, and depending on the food load, e.g. the food weight or food height, in the processing chamber and kind of food composition applied, e.g. the water, salt, protein, carbohydrate, sugar or fat content.

In an embodiment of the invention, the processing chamber, preferably the interior space, more preferably the interior space with the holder arranged in the processing chamber, is shaped such that the RF-wave has a node substantially where the top shell and the bottom shell contact, join and/or are adjacent to each other in the closed position. This embodiment further details the preceding embodiment providing or enhancing the advantages of the preceding embodiment.

In an embodiment of the invention, the RF-wave has a node forming a plane substantially at the height where the top shell and the bottom shell contact, join and/or adjacent to each other in the closed position. This embodiment promotes an RF-wave having a plane as node, thereby advantageously relaxing the width and length, such as the diameter, of the inner space of the processing chamber, preferably the width and the length, such as the diameter, of the top shell and/or the bottom shell.

In an embodiment of the invention, the holding means (192, 192′) are arranged adjacent to the bottom rim (191) for contacting the holder substantially at the node of the RF-wave. The holding means holding the holder typically also form a splice or a clearance. The holding means are advantageously also arranged in the space where the RF-waves have a node for minimizing the absorption of RF-energy at this splice or clearance and/or disturbing the RF-waves by this splice or clearance.

In an embodiment of the invention, the holder in use inside the processing chamber is suspended from the holding means. This advantageously allows that no splice or clearance is or may be created at a location in the inner space of the processing chamber inducing a current over the splice or clearance. Thus, the loss of RF-energy by the holder and/or the holding means is minimized.

According to another aspect of the invention, a system is based on one of the independent claims or embodiments or aspects of the invention combined with anyone or any number of the dependent claims, dependent embodiments.

### DRAWINGS

The invention will be apparent from and elucidated further regarding the embodiments described by way of example in the following description and with reference to the accompanying drawings, in which:

FIG. 1 schematically shows a cross-section of a first embodiment of the system according to the invention;

FIG. 2 schematically shows another cross-section of a first embodiment of the system according to the invention;

FIG. 3 schematically shows a cross-section of a processing chamber of a first embodiment of the system according to the invention;

FIG. 4A schematically shows a second cross-section of a processing chamber of a first embodiment of the system according to the invention;

FIG. 4B schematically shows a third cross-section of a processing chamber of a first embodiment of the system according to the invention;

FIG. 4C schematically shows a fourth cross-section of a processing chamber of a first embodiment of the system according to the invention;

FIG. 4D schematically shows a fifth cross-section of a processing chamber of a first embodiment of the system according to the invention;

FIG. 4E schematically shows a sixth cross-section of a processing chamber of a first embodiment of the system according to the invention;

FIG. 5 schematically shows a cross-section of a second embodiment of the system according to the invention;

FIG. 6 schematically shows a cross-section of a first embodiment of the apparatus according to the invention;

FIG. 7 schematically shows a detail of a cross-section of a first embodiment of the apparatus according to the invention;

FIG. 8 schematically shows a perspective view of a top corner of a first embodiment of the apparatus according to the invention;

FIG. 9 schematically shows a detail of a cross-section of an RF-antenna of a first embodiment of the apparatus according to the invention;

FIG. 10A schematically shows a seventh cross-section of a processing chamber 145 of a first embodiment of the system according to the invention;

FIG. 10B schematically shows an eighth cross-section of a processing chamber of a first embodiment of the system according to the invention;

FIG. 10C schematically shows a nineth cross-section of a processing chamber of a first embodiment of the system according to the invention;

FIG. 11 schematically shows a cross-section of a third embodiment of the system according to the invention; and

FIG. 12 schematically shows a tenth cross-section of a processing chamber of a first embodiment of the system according to the invention.

The figures are purely diagrammatic and not drawn to scale. In the figures, elements which correspond to elements already described may have the same reference numerals.

### DESCRIPTION

FIG. 1 schematically shows a cross-section of a first embodiment of the system 100 according to the invention. The system comprises an RF-impermeable layer 110, a holder 120, and an apparatus 140. The holder comprises an air-permeable side 121. The apparatus comprises a processing chamber 145, holding means 148, 148′, an RF-antenna 155, 155′, a fan 156 and a heater 157, 157′. The apparatus may further comprise a housing 141 housing all the features of the apparatus.

The processing chamber of the apparatus may comprise a top shell 146 and a bottom shell 147. The top shell and the bottom shell may be position in a closed position where the top and bottom shells form the RF-impermeable and air-impermeable layer of the processing chamber. The apparatus is shown in a closed position with the holder arranged inside the processing chamber. The holder may comprise a handle 125. The handle may partly stick out of the apparatus for easy removal of the holder when the apparatus or processing chamber is in an open position. The open position of the apparatus is when the top and bottom shell are separated in such a way that the holder may be removed from or positioned in the apparatus, more specifically in the processing chamber. In an alternative embodiment, the holder is kept in the bottom shell when loading and unloading food from the holder. In this alternative embodiment, the holder is only separated from the bottom shell for cleaning purposes. In an alternative embodiment, the top shell and the bottom shell may respectively be a front door and a back shell. In even another embodiment, the top shell and the bottom shell may respectively be a front shell and a back shell. In an embodiment of the holder, the holder comprises a detachable handle 125. The detachable handle provides the advantage of minimizing the number of excessively protruding elements of the holder such that it may easer fit in e.g. a dish cleaner or a cupboard.

The holding means are arranged inside the processing chamber for arranging or positioning the holder. The holder may be a ring or rectangle, only supporting the outer edge of the holder. The holder may be a layer partly or fully covering the bottom of the holder. This layer may be air-impermeable and/or RF-impermeable. In an alternative embodiment an edge of the top shell couples with the top edge of the holder for forming an RF-enclosed space, while the air-impermeable layer of the processing chamber is separate from the RF-impermeable layer, wherein the air-impermeable layer of the processing chamber is enclosing the RF-impermeable layer of the processing chamber, and wherein the RF-impermeable layer of the processing chamber and the RF-impermeable holder form together the first area. In this alternative embodiment, the air may circulate back in the space between the air-impermeable layer and the RF-impermeable layer.

The embodiment shows two RF-antennas, but the inventor has also envisioned embodiments using only one RF-antenna. The inventor has also envisioned to use a plurality of RF-antennas for directing the RF-energy in a particular direction, such as in the direction of the food held in the holder. Furthermore, with the use of two or more RF-antennas, at least one RF-antenna can be used for supplying RF-energy and the one or more RF-antenna not supplying RF-energy may be used for measuring or sensing the effectiveness of the RF-energy transmission towards the food in the holder or may be used to determine the characteristics of the food in the holder. For example, to determine the state of the food in the holder, being, e.g., frozen, unfrozen, or partly frozen and partly unfrozen. Also, more specific measurements may be used, such determining if the food is liquid or solid next to the states frozen and unfrozen for even better directing the RF-energy to the right locations inside the food for more even transition of the food from frozen to an unfrozen state and for more evenly cooking of the food as a whole.

The fan regulates the speed of the air stream. The heater together with the fan regulate the temperature of the air stream. The temperature of the air stream will for example drop if the speed of the air stream is increased, but also if the heater is switched off. The temperature of the air stream may range between to temperatures over 100° C., such as 100 to 250° C., preferably to 150 to 240° C., more preferably below 230° C. The fan and heater are typically arranged for air frying.

As the fan and heater may be made of materials or have a size and/or shape that reduces, disturbs or weakens the RF-waves from the RF-antenna, the fan and heater are best shielded from the RF-waves. Furthermore, the motion of the fan may worsen the influence of the fan on the RF-waves. The RF-impermeable layer is therefore arranged inside the processing chamber such that a part of the processing chamber is shielded from these one or more RF-antennas and the RF-waves emitted from these one or more RF-antennas, this part of the processing chamber is labelled second area 151. By shielding these parts, the RF-waves may reach the food in the holder undisturbed or less weakened for an improved transfer of RF-energy from the RF-antenna to the food in the holder. The part of the processing chamber exposed to RF-waves is labelled first area 150.

As the fan and heater are arranged in a RF-shielded area or in a RF low energy area, the air stream generated by the fan and heated by the heater should still be able to reach the food as well as the RF-energy. The fan is arranged such that the fan directs the air stream through the food in the holder via an air-permeable layer and/or air-impermeable side. The fan may blow the air through the food or suck the air through the food. This also allows the fan to alter the direction of the air stream for improved cooking and/or frying of the food from all sides and/or angles.

The apparatus may comprise a motor 159. The motor may be arranged below the processing chamber. FIG. 1 further shows a vertical axis V of symmetry of the apparatus. The motor may be aligned with this axle of symmetry. In an alternative embodiment, the motor may be arranged more to the backplane of the apparatus for optimizing the balance and/or stability of the apparatus, especially during loading or unloading of the holder having food in the holder. The placement of the motor may counter balance the weight of the holder and the food held in the holder, especially when the holder is resting on the apparatus while not being aligned with the vertical axis V. The apparatus may comprise an axle 164 coupling the motor to the fan providing the advantage of a very simple and failsafe coupling. Alternatively, the motor may be coupled to the fan indirectly providing the advantage of more freedom to position the motor.

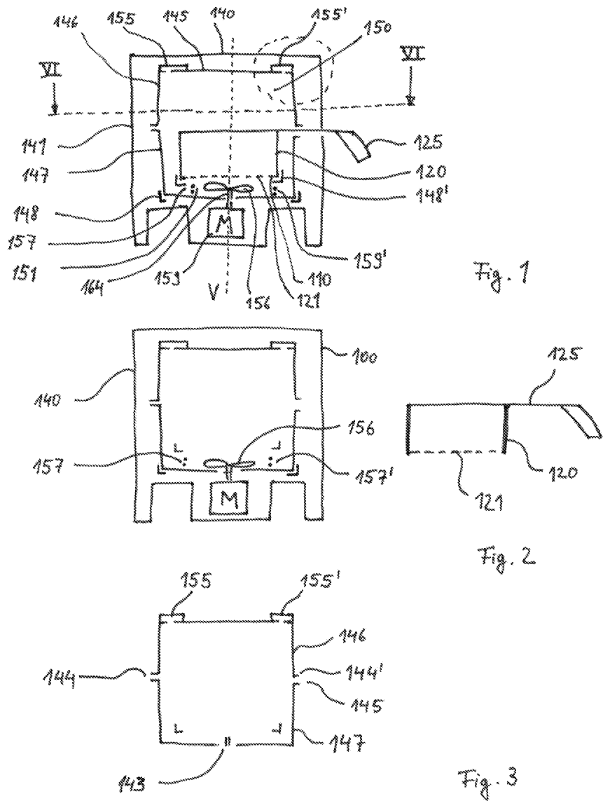

FIG. 2 schematically shows another cross-section of a first embodiment of the system 100 according to the invention. The system comprises an RF-impermeable layer 110, a holder 120, and an apparatus 140. The holder is shown outside the apparatus. In this specific embodiment, the RF-impermeable layer 110 and the air-permeable bottom side 121 of the holder are integrated. This has the technical effect, when the holder is removed, that the heater and the fan may become easily accessible for cleaning.

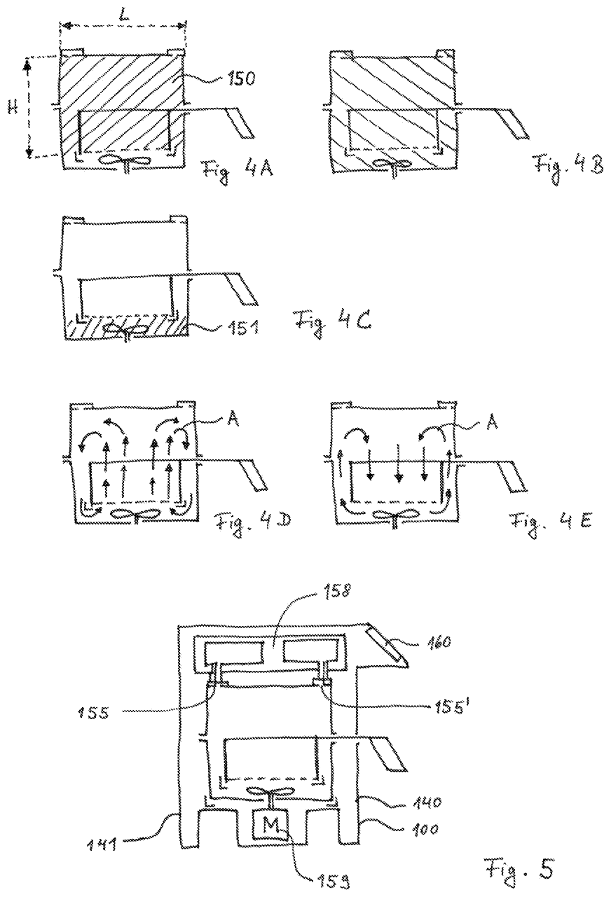

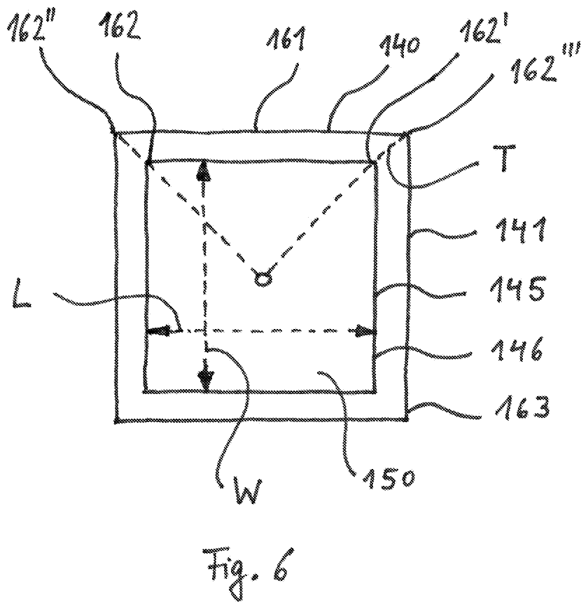

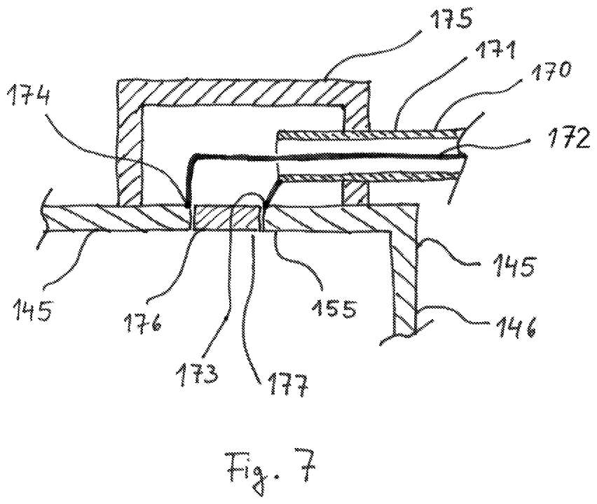

FIG. 3 schematically shows a cross-section of a processing chamber 145 of a first embodiment of the system according to the invention. The processing chamber is shown without housing and without the holder arranged in the apparatus or processing chamber. This Figure shows a possible location of the RF-antennas. This Figure details the locations where RF-energy may leak from the processing chamber. Leakage may occur at the location of the one or more RF-antennas 155, 155′. Leakage may also occur where the top shell and the bottom shell forming the processing chamber join 144, 144′. A further leakage point may be the axle opening 143 in the processing chamber. The axle opening allows the axle to pass through for driving the fan. The axle opening may be arranged to the bottom shell. This axle may further act as an antenna receiving RF-energy, typically a low amount of RF-energy as this fan is arranged in the second area which is free of RF-energy as much as possible for providing the technical effect described for the invention, worsening the potential leakage along or through the axle of the fan. Typically, the axle comprises a material with low conductive properties for RF-energy in the particular frequencies or frequencies of the RF-energy or RF-waves emitted by the RF-antennas and used for cooking. Also, typically, so called RF-traps are set up around or in the axle to trap the RF-energy and RF-wave inside the processing chamber.

Leakage typically becomes an issue when RF-waves of a frequency are used outside the ISM band. Although the ISM band is mostly freely available around the world, other frequencies are not. Especially the frequencies around 915 MHz are not free for use in e.g. Europe. This requires that the leakage should be minimized, preferably to levels which makes the system accepted throughout or almost throughout the world.

All FIG. 4 schematically show a second cross-section of a processing chamber of a first embodiment of the system 100 according to the invention. For all FIG. 4, additionally the holder 120 and the fan 156 are shown arranged inside the apparatus.

In FIG. 4A the area where the RF-energy may propagate, can propagate, or can predominantly propagate is hatched. This area inside the processing chamber is labelled the first area 150. The boundaries of the first area comprise the sides of the processing chamber and the RF-impermeable layer arranged inside the processing chamber. The length L and the height H of the first area are show in FIG. 4A.

In FIG. 4B the area where the air may circulate, can circulate, or will predominantly circulate is hatched. It is shown that the hot air may circulate through the whole processing chamber. The invention also comprises embodiments wherein only a part of the processing chamber is used for circulating the hot air for cooking. An exemplary embodiment is where the sides of the processing chamber being RF-impermeable and air-permeable are separated or spaced apart. RF-impermeable material may also have high heat conductive properties. This separation or spacing may be advantageous where materials are used both being RF-impermeable and heat conductive for preventing the outside of the processing chamber becoming hot in use.

FIG. 4C shows the subtraction of the area hatched in FIG. 4B from the first area, which is the hatched area in FIG. 4A. The result of the subtraction is, predominantly is or substantially is the area where the circulated hot air may get, but where the RF-energy or RF-waves cannot come or are greatly minimized. This resulting area is labelled the second area 151.

FIG. 4D schematically shows a fifth cross-section of a processing chamber of a first embodiment of the system according to the invention. The arrows in the Figure show a typical airflow A of the air circulating through the food and back along the sides between the holder and the processing chamber. The circulation is maintained with the use of the fan at the bottom of the processing chamber.

FIG. 4E schematically shows a sixth cross-section of a processing chamber of a first embodiment of the system according to the invention. FIG. 4E is identical to FIG. 4D except for the direction of the airflow A, which is revered in comparison to FIG. 4D.

FIG. 5 schematically shows a cross-section of a second embodiment of the system 100 according to the invention. Additionally, to the first embodiment, this embodiment also comprises the RF-sources 158 feeding the RF-antennas with energy for emitting RF-waves or RF-energy from the RF-antennas. Further, the system comprises a controller 160 and a motor 159. The motor is arranged for driving the fan. As the motor may emit RF-radiation disturbing the RF-waves, the motor is advantageously arranged outside the processing chamber. The heater may be arranged to the outside the processing chamber or integrated in a side of the processing chamber for providing heat to the air stream inside the processing chamber, such as conducting thermal energy through the side of the chamber. In this embodiment, the heater is arranged inside the processing chamber.

The controller may be arranged for receiving input from an operator. The controller may be arranged for controlling the heater and the fan for controlling the cooking effect of the hot air passing through or along the food. The controller may be arranged for controlling the RF-source for controlling the amount of RF-energy, the frequency of the RF-waves and/or the RF-mode of the RF-waves for controlling the cooking effect of the RF-energy radiated towards the food. The RF-source may comprise an RF-amplifier, such as a solid-state amplifier, controlling the RF-energy with high precision such as stepless controlling the RF-energy emitted. The RF-source may comprise an RF-signal generator for generating the frequency of the RF-wave.

The controller may use the settings of the operator for controlling or setting the RF-source, the fan and/or the heater. Additionally, or alternatively, the controller may use sensors for determining the settings of the RF-source, the fan and/or the heater. A sensor may be a temperature sensor, such as an IR-sensor, sensing the temperature of the food inside the holder. A sensor may be a temperature sensor sensing the temperature of the circulated hot air for indirectly determining the temperature of the food in the holder by comparing the measured temperature against the amount of energy introduced by the heater and the air speed generated by the fan. A sensor may be an RF-antenna not emitting RF-energy for determining the RF-energy emitted by another RF-antenna and the effect on the food in the holder. Using multiple RF-antennas as a sensor may provide an accurate image to the controller of the amount of food in the holder, such as the number of kilograms, as well as the texture of the food and/or the state of the food, such as the food being frozen, unfrozen or partly frozen and unfrozen.

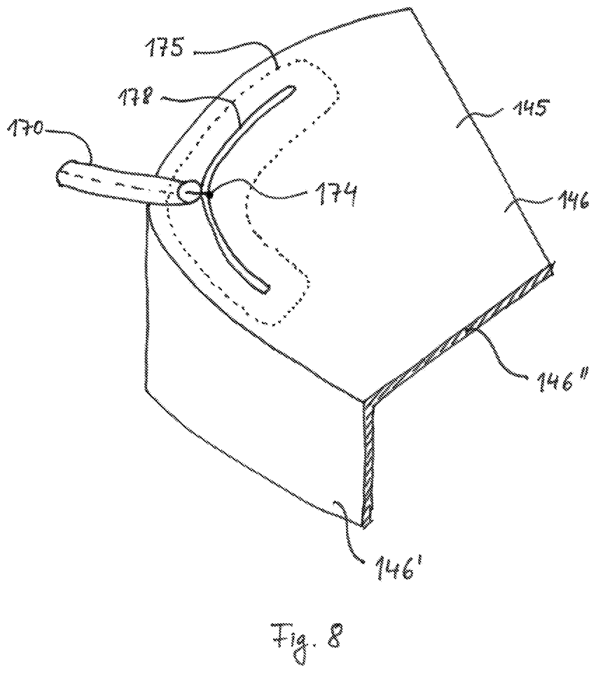

FIG. 6 schematically shows a cross-section of a first embodiment of the apparatus 140 according to the invention. The location of the cross-section is shown in FIG. 1. The cross-section of FIG. 1 is taken vertically, the cross-section of FIG. 6 is taken horizontally. The apparatus comprises a processing chamber 145, which processing chamber may comprise a top shell 146. The apparatus may further comprise a housing 141. The housing typically provides a frame or structure for arranging the elements of the apparatus to each other. The length L and the width W of the first area 150 inside the processing chamber are shown in FIG. 6. The height at which the cross-section is taken is the height which may be designated as unoccupied section inside the processing chamber.

The dimensions, being length, width and height, of the first chamber highly influence the damping or stimulating of frequencies of the RF-waves and highly influences the mode of the RF-waves.

The dominant RF-wave in the unoccupied section is a standing RF-wave. The size and/or shape of the first area, typically at least the length and the width, are selected such that one or two standing waves are formed. A standing wave provides a means for efficiently transferring the RF-energy from the RF-antenna to the food. A standing wave may have energy hotspots. A further advantage may be to have two dominant standing waves for more evenly spreading the RF-energy inside the food. To enhance the forming of two dominant standing waves, the length and width of the first area may be selected slightly different.

The dominant standing RF-wave in the unoccupied section may be an RF-wave having TE-mode 011, TE-mode 111, and/or TM-mode 110. Especially the combination of TE-mode 011 and TE-mode 111 seem beneficial as these modes require substantially the same length and width of the first area for being the dominant standing RF-waves.

The RF-antenna may operate in a frequency range fully penetrating the food in the holder, wherein the food in the holder has a weight over 2 Kg, preferably 3 Kg, more preferably over 4 Kg. These amounts of food are typically used in commerce and not for home use. The frequency for the RF-waves and the size and/or shape of the processing chamber are to be advantageously selected and sized and/or shaped respectively to accommodate this amount of food in the holder.

The RF-antenna may operate in a frequency range fully penetrating the food in the holder, wherein the frequency range is below 1 GHz, preferably within the 902 to 928 MHz band or substantially 915 MHz. The amounts of food, as specified above, have to be penetrated by the RF-waves for providing the RF-energy everywhere inside the food. The typically used frequency of 2.45 GHz is not suitable as the penetration depth is only in the range of centimetres, thus not good enough to penetrate food blocks weighing over 2 Kg. Selecting a lower frequency advantageously allows the RF-wave to penetrate the food deeper, instead of only heating the outside layer of the food. If the frequency is selected even such low that the RF-wave traversing through the food is only partially absorbed, the RF-wave may consequently bounce back from the processing chamber and/or RF barrier separating the first and second area for thereafter traversing the food again for heating the food by being absorbed. It provides the advantage that the food is more evenly heated during, e.g., the transition from frozen to unfrozen. This provides the further advantage that the food is less heated with hotspots determined by the standing wave, but also by the more randomized reflections enhancing the evenly spreading of absorbed RF-energy in the food.

It is an insight of the inventor, based on extensive characterization of various food and conditions, that the frequency range of 902 to 928 MHz has one or more advantages over other frequencies such at the range of 2390 to 2450 MHz. Also, in various countries, this frequency band of 902 to 928 MHz can be used freely, unlicensed band. In many other countries however, very strict regulations apply for that frequency range and provisions have to be taken to prevent electro-magnetic-interference. Hence, selecting a frequency in this range advantageously eases the compliance with those different requirements and still achieves a good performance, especially at 2.45 GHz ISM band worldwide and not only at the 915 MHz band for the Americas. Thus, production is simplified by selecting a frequency in this range, while this frequency range also provides the benefit of high penetration of the food in the holder.

The dominant RF-waves may have a frequency below 1 GHz, preferably within the 902 to 928 MHz band or substantially 915 MHz, and the dominant RF-waves have at least one, preferably both, a TE-mode 011 and/or a TE-mode 111. Experiments and tests of the inventor have shown that with the before mentioned parameters, the length and width of the processing chamber get in the range of 250 to 380 mm, preferably in the range of 280 to 340 mm, more preferably around 306 mm. This dimension may also refer to a certain size of the RF-impermeable wall of the holder and may be adjusted accordingly to the overall, effective processing chamber. The height of the first area during the experiments and tests was in the range of 180 mm, more specifically 192 mm, while the height of the holder was less than half 60% of the height of the first area. Furthermore, it was assumed that the dielectric constant of air was around 1, of the RF-permeable sides of the holder around 3-10, depending on the material of the holder, such as PTFE, PEEK, fibreglass or ceramics, and of the frozen food around 80, while unfrozen but cold food may be around 3. Typically, as temperature increases, permittivity of the food ends up around 40 for mainly water-based food products, e.g. hot snack food with moist insides, while the crispy crust settle around 80. These dimensions are well suited for holding more substantial amounts of food, especially for commercial use. This embodiment may be valid for compact size general equipment or counter-top equipment, it may be further enhanced by selecting a different length and width for the first area, but still in the range specified for advantageously spreading the RF-energy more evenly, as specified before. For larger size equipment, beyond counter-top placements, a frequency of 433 MHz could be selected to support food loads of 8 kg and more.

The dominant RF-waves may have a frequency below 1 GHz, preferably within the 902 to 928 MHz band or substantially 915 MHz, and the dominant RF-wave has a TM-mode 110. Experiments and tests of the inventor have shown that with the before mentioned parameters, the length and width of the processing chamber get in the range of 200 to 260 mm, preferably in the range of 220 to 240 mm, more preferably around 230 mm. The height of the first area during the experiments and tests was in the range of 180 mm, while the height of the holder was less than half the height of the first area. Furthermore, it was assumed that the dielectric constant of air was around 1, of the RF-permeable sides of the holder around 2 (PTFE), 3 to 4 (PEEK, fibreglass) to around 10 (ceramics) and the permittivity of the food in a very wide range from 3 to 80; while very low numbers may be for frozen food and high numbers for cold but non-frozen. As temperature increases, permittivity typically drops to around 40; this holds for mainly water-based food products, e.g. hot snack food with moist insides and crispy crust3 and of the food around 80. These dimensions are well suited for holding more substantial amounts of food, especially for commercial use.

Experiments have shown that the length and width ratio of the first area is preferably around 1. Further experiments have shown that the height versus length or width ratio of the first area is preferably around 2. Further experiments have shown that the height of the holder and thus also the food held in the holder, should not exceed 60% of the height of the first area. These limitations to be complied to for generating RF-waves inside the processing chamber with enough or considerable efficiency.

FIG. 6 further shows the vertical axis V as a dot with a cross in it as the vertical axis is perpendicular to the plane of the cross-section. The apparatus may further comprise a housing defining the outer edge of the apparatus. The housing may comprise a backplane 161 defining the face of the apparatus typically facing away from the operator. The backplane is typically facing a wall. The housing may comprise a front plane 163. The front plane is opposite from the backplane and typically facing the operator. The backplane has a first backplane end 162 and a second backplane end 162′. The first backplane end, the second backplane end and the vertical axis define a triangle T.

FIG. 7 schematically shows a detail of a cross-section of a first embodiment of the apparatus according to the invention. The detail shows the RF-antenna 155′ in the top right corner of FIG. 1.

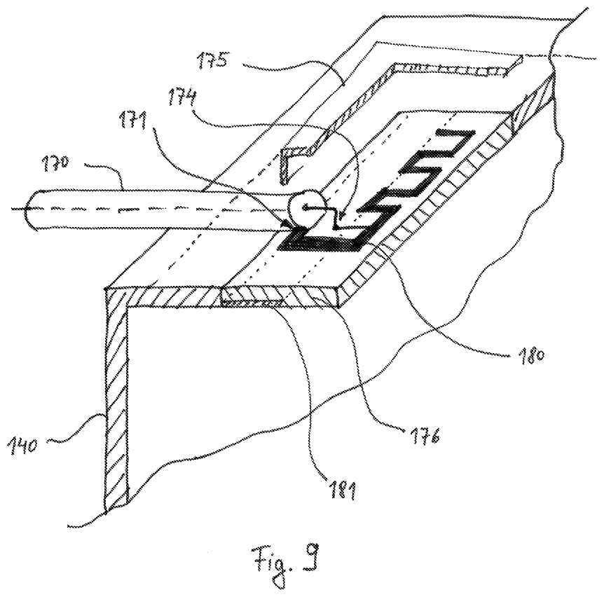

The RF-antenna may comprise a slot 178, a shielding box 175, a RF-transparent layer 176, an RF-transparent surface 177. The slot 178 is not shown in FIG. 7, but for example is shown in FIG. 8.

The RF-antenna is fed with energy or signal through an RF-cable 170. The RF-cable comprises a core 172 and a shield 171. The core typically carries the signal, while the shield shields the core from emitting RF-waves outside the RF-cable. The Rf-cable may be a coaxial cable.

The RF-antenna may be a slotted antenna or inverse antenna as shown. Other types of RF-antennas may be used for radiating the RF-energy. The RF-antenna may further comprise an RF-transparent layer 176 having an RF-transparent surface 177. The RF-transparent surface is sealing off the inside of the shielded box to prevent dirt accumulating inside the shielded box and/or for easing cleaning of the inside of the processing chamber. The RF-transparent layer preferably seamlessly connects with the inner surface of the processing chamber. The RF-transparent layer preferably is flush with the inner surface of the processing chamber. The inside of the shielded box may be seen as a protrusion of the processing chamber. The RF-transparent layer is typically of a material which easily allows the conductance of RF-waves. The RF-transparent layer is therefore having a suitable dielectric constant.

The RF-antenna couples to the slotted antenna by having the RF-cable core 172 couple to a second RF-cable feed point 174, which is an edge of the processing chamber on one side of the slot, and the RF-cable shield 171 couple to a first RF-cable feed point 173, which is another edge of the processing chamber on an opposite side of the slot. The slot has a circumference which is typically of a length λ equalling the wavelength of the dominant to be generated RF-wave.

FIG. 8 schematically shows a perspective view of a top corner of a first embodiment of the apparatus according to the invention. The RF-antenna 155, 155′ is of the typed slotted antenna. The RF-antenna comprises a slot 178, which may be bend as shown. Other slot shapes, such as straight are envisioned by the inventor.

The processing chamber 145 may comprise a top shell 146. The processing chamber may comprise a side wall 146′ and a top wall 146″. The RF-antenna may alternatively be placed in the side wall. For clarity purposes, the shielded box is left away in this Figure and therefore drawn dotted, but it should be clear to the skilled person in the art to understand that in use the shielded box is arranged to the RF-antenna for preventing RF-waves to escape from the enclosure of the processing chamber.

FIG. 9 schematically shows a detail of a cross-section of an RF-antenna of a first embodiment of the apparatus according to the invention. The RF-antenna is an example of an inverted antenna, more specifically a planar inverted antenna or PIFA. The RF-antenna comprises a conductive antenna trace 180 which meanders to shorten the overall length of the antenna. The RF-antenna further comprises a ground plane 181. The RF-cable 170, which may be a coax-cable, may comprise a core 172 and a shield 171 coupled respectively to the antenna trace 180 via the second RF-cable feed point 174, and to the ground plane 181 via the first RF-cable feed point 173.

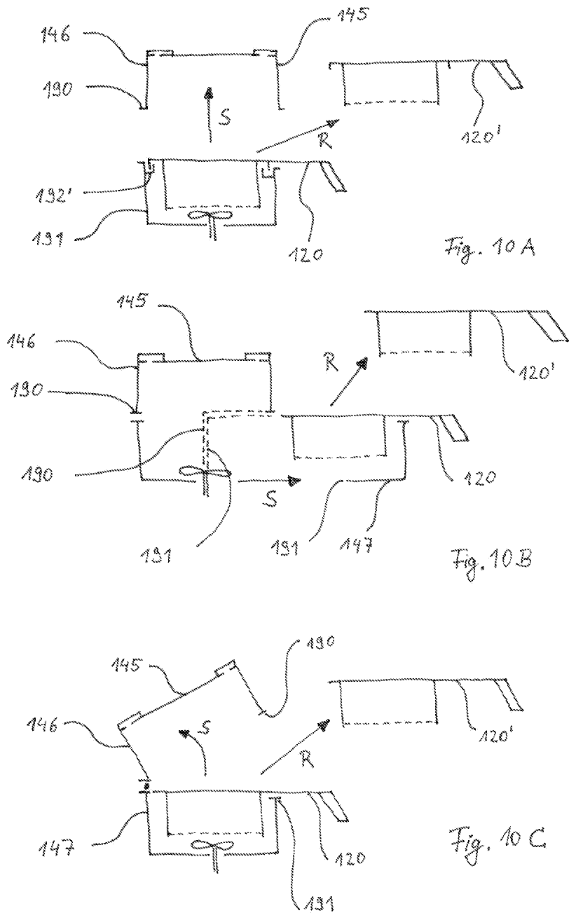

FIG. 10A schematically shows a seventh cross-section of a processing chamber 145 of a first embodiment of the system according to the invention. With reference to earlier figures, the same reference numeral may indicate the same feature. The processing chamber comprises a bottom shell 147 and a top shell 146. The bottom shell has a bottom rim 191, and the top shell a top rim 190. The processing chamber is shown in an open position. In this embodiment the top shell can be taken away from the bottom shell. The holder 120 is shown when held by the holding means arranged in the bottom shell. Further, the holder 120′ is shown when separated from the processing chamber. The holder 120 can be moved in a direction R to the position indicated with the holder 120′.

FIG. 10B schematically shows an eighth cross-section of a processing chamber of a first embodiment of the system according to the invention. With reference to FIG. 10A, the same reference numeral may indicate the same feature. The bottom shell slides horizontally away from the top shell for separating from the top shell in a direction S.

FIG. 10C schematically shows a nineth cross-section of a processing chamber of a first embodiment of the system according to the invention. With reference to FIG. 10A, the same reference numeral may indicate the same feature. The top shell hinges with the bottom shell in this embodiment.

FIG. 11 schematically shows a cross-section of a third embodiment of the system according to the invention. With reference to earlier figures, the same reference numeral may indicate the same feature. The apparatus comprises holding means 192, 192′ arranged inside the processing chamber. The holdings means are arranged for suspending the holder 120.

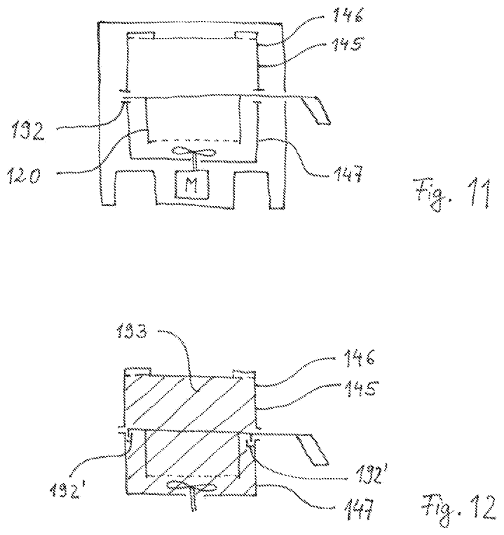

FIG. 12 schematically shows a tenth cross-section of a processing chamber of a first embodiment of the system according to the invention. With reference to earlier figures, the same reference numeral may indicate the same feature. The processing chamber 145 comprises a top shell 145 and a bottom shell 146 shown in a closed position. Further, the holder 120 is at least partly arranged inside the processing chamber. The space enveloped or enclosed by the processing chamber is the interior space 193.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

In the preceding specification, the invention has been described with reference to specific examples of embodiments of the invention. It will, however, be evident that various modifications and changes may be made therein without departing from the scope of the invention as outlined in the appended claims. For example, the shapes may be any type of shape suitable to achieve the desired effect. Devices functionally forming separate devices may be integrated with a single physical device.

However, other modifications, variations, and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ or ‘including’ does not exclude the presence of other elements or steps than those listed in a claim. Furthermore, the terms “a” or “an,” as used herein, are defined as one or as more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

### EMBODIMENTS

1. System (100) for preparing food, comprising:

an RF-impermeable layer (110);

a holder (120) for holding the food, comprising an air-permeable side (121); and

an apparatus (140) comprising:

a processing chamber (145) arranged for being RF-impermeable and preferably air-impermeable;

holding means (148, 148′) for holding the holder inside the processing chamber;

an RF-antenna (155, 155′) arranged to radiate RF-energy to the inside of the processing chamber for heating the food inside the holder;

a fan (156) for circulating the air in the processing chamber through the air-permeable side and through the holder; and

a heater (157, 157′) arranged to provide heat to the circulated air,

wherein:

the fan and the heater are arranged for air frying the food inside the holder,

the RF-impermeable layer is also air-permeable and at least in use arranged substantially parallel to the air-permeable side of the holder,

the RF-impermeable layer in use separates the processing chamber in a first area (150) susceptible to RF-energy from the RF-antenna and a second area (151) shielded off from RF-energy from the RF-antenna; and

the fan is arranged in the second area.

2. System according to the preceding embodiment, wherein the provision of RF-energy to the food inside the holder is independent of the provision of heated air to the food inside the holder.

3. System according to any of the preceding embodiments, wherein the air-permeable side is arranged for allowing a vertical stream of air (A) through the holder.

4. System according to any of the preceding embodiments, wherein the air-permeable side of the holder is an air-permeable bottom side (121).

5. System according to any of the preceding embodiments, wherein the holder comprises the RF-impermeable layer.

6. System according to the preceding embodiment, wherein the RF-impermeable layer is a bottom-side of the holder, preferably wherein the RF-impermeable layer and the air-permeable side are integrated.

7. System according to the preceding embodiment 5, wherein the RF-impermeable layer is a top-side of the holder.

8. System according to any of the preceding embodiments, wherein the holding means are at least partly RF-impermeable for in use together with the RF-impermeable layer forming an RF separation in the processing chamber.

9. System according to any of the preceding embodiments, wherein the heater is arranged in the second area.

10. System according to the preceding embodiment, wherein the heater is at least partly RF-impermeable for in use together with the RF-impermeable layer forming an RF-separation in the processing chamber.

11. System according to any of the preceding embodiments, comprising:

an RF-source (158) arranged for providing RF-energy to the RF-antenna;

a motor (159) for driving the fan;

a heater source for providing energy to the heater; and

a controller (160) for controlling the amount of RF-energy from the RF-source, the number of revolutions of the motor, and the amount of radiated heat from the heater, wherein the controller controls the RF-source, the motor, and the heater independently.

12. System according to any of the preceding embodiments, wherein the holder is a food basket.

13. System according to any of the preceding embodiments, wherein the system is combined with any of the features from the claims chapter.

### LIST OF REFERENCE NUMERALS

100 system

110 RF-impermeable layer

120, 120′ Holder

121 (4) air-permeable side

125 handle of the holder

140 apparatus

141 housing

143 axle opening

144, 144′ joining shells

145 (5) processing chamber

146 (31) top shell

146′ side wall

146″ top wall

147 (32) bottom shell

148, 148′ (6, 6′) holding means

150 (10) first area

151 (11) second area

155, 155′ (7, 7′) RF-antenna

156 (8) fan

157, 157′ (9, 9′) heater

158 (15) RF-source

159 (16) motor

160 (20) controller

161 backplane

162, 162′ inner corner processing chamber

162″ first backplane end

162″′ second backplane end

163 front plane

164 Axle

170 RF-cable

171 RF-cable shield

172 RF-cable core

173 first RF-cable feed point

174 second RF-cable feed point

175 shielding box

176 RF-transparent layer

177 RF-transparent surface

178 Slot

180 antenna trace

181 ground plane

190 top rim

191 bottom rim

192, 192′ holding means

193 interior space

A air flow

H height of the first area

L length of the first area

R removal direction holder

S separation direction shells

T Triangle

V vertical axis

W width of the first area

1-40. (canceled)

41. A system for preparing food, the system comprising:
an RF-impermeable layer;
a food holder for holding the food, the food holder including an air-permeable side; and
an apparatus that includes:
a processing chamber that is RF-impermeable and air-impermeable;
a holding mechanism for holding the food holder inside the processing chamber;
an RF-antenna to radiate RF-energy to an inside of the processing chamber for heating the food inside the food holder;
a fan to circulate air in the processing chamber through the air-permeable side and through the food holder; and
a heater arranged to provide heat to the circulated air,
wherein:
the fan and the heater are arranged for air frying the food inside the holder,
the RF-impermeable layer is air-permeable and at least in use arranged substantially parallel to the air-permeable side of the food holder,
the RF-impermeable layer is to separate the processing chamber in a first area susceptible to RF-energy from the RF-antenna and a second area shielded from RF-energy from the RF-antenna; and
the fan is arranged in the second area.

42. The system of claim 41, wherein a provision of RF-energy to the food inside the food holder is independent of a provision of heated air to the food inside the food holder.

43. The system of claim 41, wherein the air-permeable side is to allow a vertical stream of air through the food holder.

44. The system of claim 41, wherein the air-permeable side of the holder is an air-permeable bottom side.

45. The system of claim 41, wherein the food holder comprises the RF-impermeable layer.

46. The system of claim 45, wherein the RF-impermeable layer is a top-side of the holder.

47. The system of claim 41, wherein:
the RF-impermeable layer is a bottom-side of the food holder, and
the RF-impermeable layer and the air-permeable side are integrated.

48. The system of claim 41, wherein the holding mechanism is at least partly RF-impermeable for in use together with the RF-impermeable layer forming an RF separation in the processing chamber.

49. The system of claim 41, wherein the heater is arranged in the second area.

50. The system of claim 41, wherein the heater is at least partly RF-impermeable for in use together with the RF-impermeable layer forming an RF-separation in the processing chamber.

51. The system of claim 41, further comprising:
an RF-source to provide RF-energy to the RF-antenna;
a motor to drive the fan;
a heater source to provide energy to the heater; and
a controller to control the RF-source, the motor, and the heater independently in such a manner to control an amount of RF-energy from the RF-source, a number of revolutions of the motor, and an amount of radiated heat from the heater.

52. The system of claim 41, wherein the food holder comprises a food basket.
